(19) United States
(12) Patent Application Publication
(10) Pub. No.: US 2026/0080564 A1
(43) Pub. Date: Mar. 19, 2026

(54) INFORMATION PROCESSING APPARATUS AND INFORMATION PROCESSING METHOD

(71) Applicant: CANON KABUSHIKI KAISHA, Tokyo (JP)

(72) Inventor: HIROICHI YAMAGUCHI, Kanagawa (JP)

(21) Appl. No.: 19/307,404

(22) Filed: Aug. 22, 2025

(30) Foreign Application Priority Data
Sep. 18, 2024 (JP) 2024-161043

(51) Int. Cl. G06T 7/73; G06T 5/77; G06T 7/00

(52) U.S. Cl. CPC G06T 7/73; G06T 5/77; G06T 7/0002; G06T 2207/10016; G06T 2207/30168

(57) ABSTRACT

An information processing apparatus includes: a processor; and a memory storing a program which, when executed by the processor, causes the information processing apparatus to execute reception processing of receiving an image from an apparatus, and execute acquisition processing of acquiring a position or an orientation of the apparatus on a basis of a second region excluding a first region including a data error or a data loss in the image.

### BACKGROUND

### Field of the Technology

The present disclosure relates to an information processing apparatus and an information processing method.

### Description of the Related Art

In recent years, a mixed reality (MR) technique is known as a technique for seamlessly merging a real world with a virtual world in real time. A user can experience a mixed reality space by the MR technique by using, for example, a video see-through type head mounted display (HMD). The HMD captures an object substantially coinciding with an object observed from a position of a pupil of the user with a video camera or the like, and displays an image in which computer graphics (CG) is superimposed on the captured image.

The video see-through type HMD captures the object with a charge-coupled device such as a CCD to acquire digital image data of the object, and displays an MR image (mixed reality image) on which a CG image is superimposed to the user (wearer) via a display device such as a liquid crystal or an organic EL. Processing of superimposing the CG image on the captured image may be executed by an external apparatus having higher processing performance than the HMD. In this case, the HMD transmits the captured image captured by the HMD to the external apparatus. The external apparatus acquires a position and an orientation of the HMD by using the captured image received from the HMD. The external apparatus generates a mixed reality image in which the CG image is superimposed on the captured image on the basis of the acquired position and orientation of the HMD, and transmits the generated mixed reality image to the HMD. The HMD displays the mixed reality image received from the external apparatus. As a result, the user wearing the HMD can experience the MR space.

Japanese Patent Laid-Open No. 2016-001397 proposes a method in which an image in which an abnormality is detected is not used for learning in an image processing apparatus that detects an object appearing in a moving image while learning a dictionary.

In a case where the captured image is not used to acquire the position and orientation because there is an abnormality in a part of the captured image received to acquire the position and orientation of the HMD, when the abnormality occurs continuously, it may be difficult for the external apparatus to stably acquire the position and orientation of the HMD.

### SUMMARY

The present disclosure provides an information processing apparatus capable of stably acquiring a position and an orientation even in a case where there is an abnormality in a part of an captured image for acquiring the position and the orientation.

An information processing apparatus according to the present disclosure includes: a processor; and a memory storing a program which, when executed by the processor, causes the information processing apparatus to execute reception processing of receiving an image from an apparatus, and execute acquisition processing of acquiring a position or an orientation of the apparatus on a basis of a second region excluding a first region including a data error or a data loss in the image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a system according to the present disclosure.

FIG. 2 is a block diagram of an HMD and an information processing apparatus according to a first embodiment.

FIGS. 3A to 3C are diagrams illustrating captured images according to the first embodiment.

FIG. 4 is a flowchart illustrating position and orientation acquisition processing according to the first embodiment.

FIG. 5 is another example of the block diagram of the HMD and the information processing apparatus according to the first embodiment.

FIG. 6 is a block diagram of an HMD and an information processing apparatus according to a second embodiment.

FIGS. 7A to 7C are diagrams for explaining image processing according to the second embodiment.

FIG. 8 is a flowchart illustrating position and orientation acquisition processing according to the second embodiment.

FIG. 9 is a block diagram of an HMD and an information processing apparatus according to a third embodiment.

FIGS. 10A and 10B are diagrams for explaining image processing according to the third embodiment.

FIG. 11 is a flowchart illustrating position and orientation acquisition processing according to the third embodiment.

FIG. 12 is a diagram illustrating time-series captured images by a plurality of imaging units.

FIG. 13 is a flowchart illustrating position and orientation acquisition processing according to a fourth embodiment.

FIG. 14 is a flowchart of position and orientation acquisition processing using an image of one imaging unit.

### DESCRIPTION OF THE EMBODIMENTS

### First Embodiment

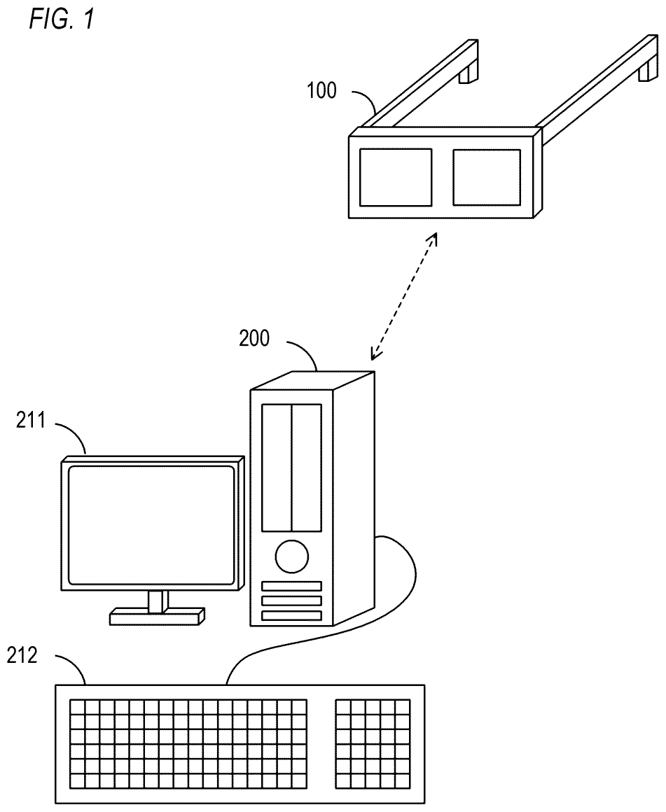

Hereinafter, embodiments of the present disclosure will be described with reference to the drawings. FIG. 1 is a diagram illustrating a configuration of a system according to the present disclosure. The system illustrated in FIG. 1 includes a head-mounted display (HMD) 100 and an information processing apparatus 200. The information processing apparatus 200 is connected to a display unit 211 and an operation unit 212. The present disclosure is applied when the information processing apparatus 200 acquires a position and an orientation of the HMD 100 in order to generate an image to be displayed on the HMD 100. Hereinafter, the system illustrated in FIG. 1 will be described on the assumption of an MR system, but may be a virtual reality (VR) system or an augmented reality (AR) system.

The HMD 100 is worn on a head of a user. The HMD 100 includes a control unit, and controls a display unit, a communication unit, and the like included in the HMD 100. The HMD 100 receives the image generated by the information processing apparatus 200 via the communication unit. The HMD 100 displays the received image on the display unit. The display unit of the HMD 100 includes an optical system disposed in front of each of left and right eyes of the user.

The HMD 100 can communicate with the information processing apparatus 200 via a small network such as a wireless local area network (WLAN) or a wireless personal area network (WPAN). A wired communication method may be used between the HMD 100 and the information processing apparatus 200 without being limited to a wireless communication method.

The information processing apparatus 200 includes a control unit, and controls a reproduction unit, a storage unit, a communication unit, and the like included in the information processing apparatus 200. The control unit can realize processing of each unit of the information processing apparatus 200 by loading a program stored in the storage unit in a memory and executing the program. The reproduction unit generates an image to be reproduced by the HMD 100. The storage unit stores the image generated by the reproduction unit. The information processing apparatus 200 communicates with the HMD 100 via the communication unit. For example, the information processing apparatus 200 transmits the image stored in the storage unit to the HMD 100 via the communication unit.

The operation unit 212 connected to the information processing apparatus 200 is an input apparatus such as a keyboard. The user can input data, a command, and the like by using the operation unit 212. The display unit 211 displays data input by the user, a result of processing based on a command from the user, and the like.

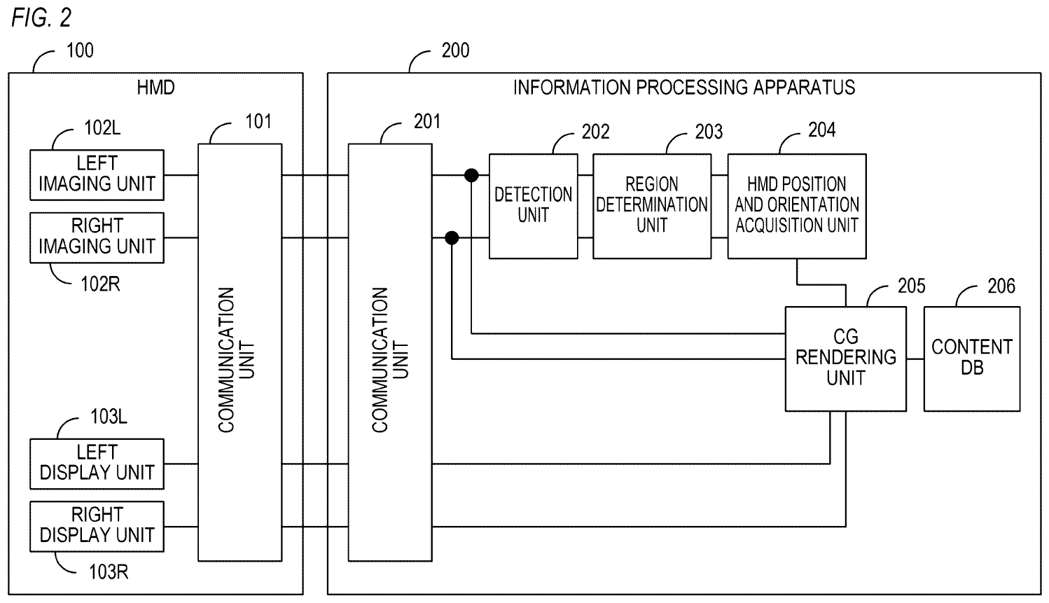

FIG. 2 is an example of a block diagram of the HMD 100 and the information processing apparatus 200 according to the first embodiment. The HMD 100 includes a communication unit 101, a left imaging unit 102L, a right imaging unit 102R, a left display unit 103L, and a right display unit 103R.

The communication unit 101 is a communication interface for communicating with an external apparatus such as the information processing apparatus 200. The communication unit 101 transmits and receives various kinds of data such as an image and various control signals to and from the information processing apparatus 200, for example. The left imaging unit 102L and the right imaging unit 102R capture an outside world from substantially the same position as the user's eyes. The left imaging unit 102L and the right imaging unit 102R are also collectively referred to as an imaging unit 102.

The left display unit 103L and the right display unit 103R display images (stereo images) to the user wearing the HMD 100. The left display unit 103L displays an image for the user's left eye, and the right display unit 103R displays an image for the user's right eye. The left display unit 103L and the right display unit 103R are also collectively referred to as a display unit 103.

The information processing apparatus 200 is an external apparatus different from the HMD 100, such as a personal computer (PC), a workstation (WS), or a cloud server via a public network or the like. The information processing apparatus 200 includes a communication unit 201, a detection unit 202, a region determination unit 203, an HMD position and orientation acquisition unit 204, a CG rendering unit 205, and a content DB 206.

The communication unit 201 is a communication interface for communicating with an external apparatus such as the HMD 100. The communication unit 201 transmits and receives various data such as an image and various control signals to and from the HMD 100, for example.

The detection unit 202 determines an error portion from the captured image received from the HMD 100. The error portion is a portion where a data error such as a packet error or a data loss such as a packet loss occurs in the data of the received captured image. The region determination unit 203 determines a region on the captured image corresponding to the portion where the data error or the data loss occurs.

The HMD position and orientation acquisition unit 204 acquires a position and an orientation of the HMD 100. Note that, the HMD position and orientation acquisition unit 204 may acquire the position or orientation of the HMD 100. The content DB 206 stores information of a CG content of a virtual image. The CG rendering unit 205 renders a CG image on the basis of the information of the CG content stored in the content DB 206 and the position and orientation of the HMD 100.

The information processing apparatus 200 uses an captured image of a real space received from the HMD 100 for the purpose of generating a combined image by superimposing the CG image and for the purpose of acquiring the position and orientation of the HMD 100. In the following description, the captured image used for the purpose of generating the combined image and the captured image used for the purpose of acquiring the position and orientation of the HMD 100 are images captured by the same imaging unit 102, but the present disclosure is not limited thereto. The captured image used for the purpose of generating the combined image and the captured image used for the purpose of acquiring the position and orientation of the HMD 100 may be images captured by different imaging devices.

The imaging unit 102 of the HMD 100 captures the outside world. The HMD 100 transmits the captured image to the information processing apparatus 200 via the communication unit 101. Since the communication between the HMD 100 and the information processing apparatus 200 is wireless communication, a packet error, a packet loss, and the like are likely to occur when the captured image is transmitted. In a case where the packet error or packet loss occurs, retransmission of the captured image causes a delay. In systems such as MR and VR, when a delay occurs, the user feels uncomfortable or does not feel a sense of immersion. Accordingly, even though the packet error or the packet loss occurs in the image transmitted to the information processing apparatus 200, the HMD 100 does not retransmit the image.

The information processing apparatus 200 inputs the captured image received from the HMD 100 via the communication unit 201 to the detection unit 202. The detection unit 202 detects the packet error and the packet loss occurring in wireless communication. The detection unit 202 outputs information of the portion (packet) where the packet error or the packet loss occurs in the captured image and the captured image to the region determination unit 203.

The region determination unit 203 determines a region (first region) including the packet error or the packet loss in the captured image on the basis of the information of the packet where the packet error or the packet loss occurs.

The HMD position and orientation acquisition unit 204 acquires the position and orientation of the HMD 100 on the basis of a region (second region) excluding the region including the packet error or the packet loss determined by the region determination unit 203 in the captured image.

The CG rendering unit 205 renders the CG for the left eye and the CG for the right eye on the basis of the information of the position and orientation of the HMD 100 acquired by the HMD position and orientation acquisition unit 204. The CG rendering unit 205 generates a combined image in which the rendered CG is superimposed on the captured image received from the HMD 100. The information processing apparatus 200 transmits the combined image generated by the CG rendering unit 205 to the HMD 100 via the communication unit 201. The HMD 100 displays the received combined image on the display unit 103.

The user wears the HMD 100, and thus, the user can view the combined image of the CG rendered by the information processing apparatus 200 and the captured image captured by the imaging unit 102 in accordance with a position and an orientation of the user. Note that, the information processing apparatus 200 transmits the combined image generated by the CG rendering unit 205 superimposing the CG on the captured image to the HMD 100, but is not limited thereto. The information processing apparatus 200 may transmit the CG rendered by the CG rendering unit 205 to the HMD 100, and the HMD 100 may superimpose the CG on the captured image and display the superimposed image on the display unit 103.

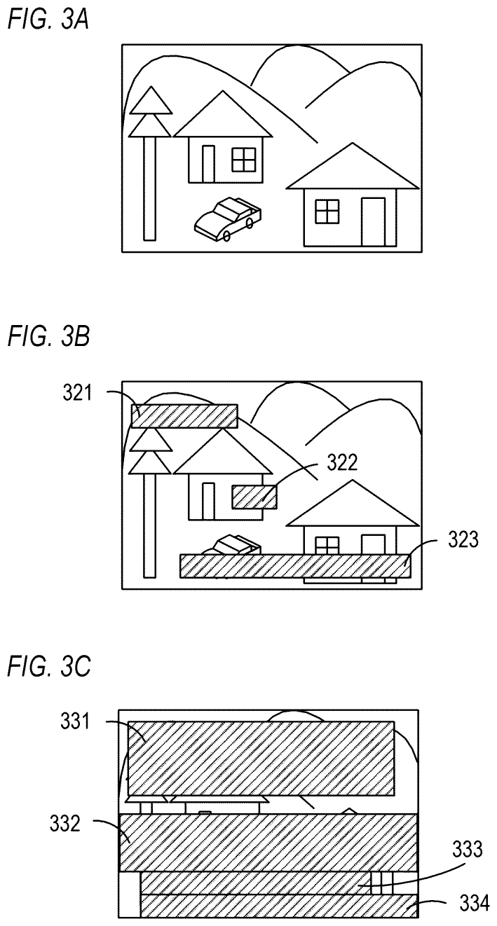

FIGS. 3A to 3C are diagrams illustrating the captured images according to the first embodiment. The information processing apparatus 200 receives the image captured by the imaging unit 102 of the HMD 100 from the HMD 100 by wireless communication. FIG. 3A illustrates the captured image received by the information processing apparatus 200, and illustrates a state where there is neither the packet error nor the packet loss. The image in FIG. 3A is a normal captured image in which the packet error or the packet loss due to wireless communication does not occur.

FIGS. 3B and 3C illustrate the captured images in a case where the packet error or the packet loss occurs in wireless communication. Regions 321 to 323 in FIG. 3B and regions 331 to 334 in FIG. 3C are regions where the packet error or the packet loss occurs. Areas of the regions 331 to 334 in FIG. 3C are larger than areas of the regions 321 to 323 in FIG. 3B.

In the region where the packet loss occurs, image data is not received due to the data loss, and thus, nothing is displayed as the image. On the other hand, in the region where the packet error occurs, a correct image is not displayed due to the data error of the image data.

As a method for calculating the position and orientation of the device such as the HMD 100 by using the captured image, a method called simultaneous localization and mapping (SLAM) is known. The SLAM is a method for detecting feature points from the captured image and estimating a self-position and an orientation by using the detected feature point.

As a representative method for detecting the feature point, a method for detecting a high-frequency component of the image and detecting a corner from the high-frequency component is known. When the feature point is detected, as illustrated in FIG. 3B, in a case where there is the region where the packet error or the packet loss occurs in the captured image, there is a possibility that an incorrect feature point is detected in the region. In the SLAM, since the position and orientation of the HMD 100 are estimated by using the feature point detected in the captured image, when the incorrect feature point is detected, there is a possibility that the position and orientation of the HMD 100 is not correctly estimated. That is, in a case where the feature point is not correctly detected from the captured image, the position and orientation of the HMD 100 acquired by the HMD position and orientation acquisition unit 204 become unstable.

In the first embodiment, the information processing apparatus 200 does not use the region including the packet error or the packet loss in the captured image for acquiring the position and orientation of the HMD 100. In a case where the captured image is transmitted by wireless communication, the information processing apparatus 200 divides the captured image into packet units and transmits the divided packet units. Since a packet size and a transmission order are known, the information processing apparatus 200 can acquire information such as which number of the received packet has an error and which number of the packet has not been received yet. The information processing apparatus 200 can determine which region of the captured image includes the packet error or the packet loss by using the information of the packet where the packet error or the packet loss occurs.

The detection unit 202 in FIG. 2 detects the packet where the packet error or the packet loss occurs in the captured image received from the HMD 100 by wireless communication. The region determination unit 203 determines the region including the packet error or the packet loss in the captured image on the basis of the information of the packet error or the packet loss detected by the detection unit 202. The region determination unit 203 outputs information of the region including the packet error or the packet loss to the HMD position and orientation acquisition unit 204. The HMD position and orientation acquisition unit 204 acquires the position and orientation of the HMD 100 from the captured image excluding the region determined by the region determination unit 203.

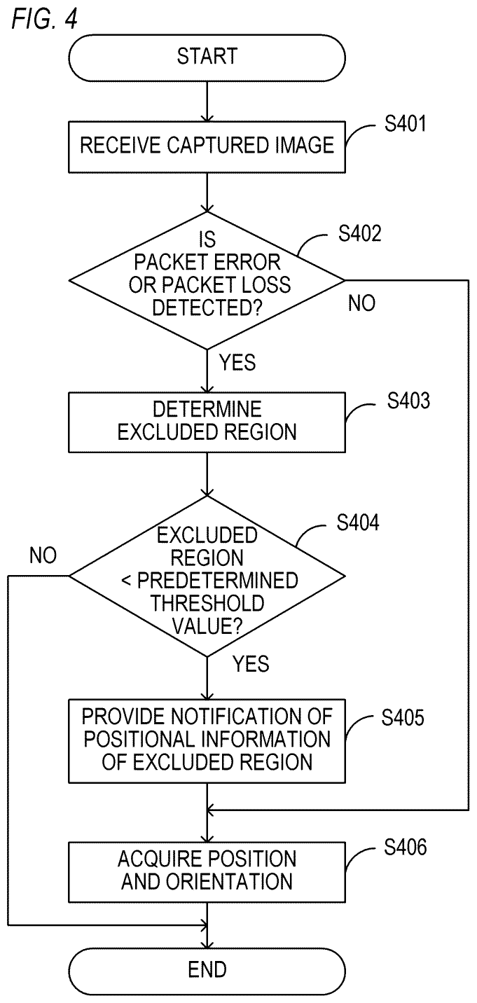

FIG. 4 is a flowchart illustrating position and orientation acquisition processing according to the first embodiment. The processing illustrated in FIG. 4 is realized, for example, by the processor of the information processing apparatus 200 loading a program for realizing a function of each unit of the information processing apparatus 200 illustrated in FIG. 2 in the memory and executing the program.

In step S401, the communication unit 201 receives the captured image for acquiring the position and orientation of the HMD 100 from the HMD 100. In step S402, the detection unit 202 determines whether or not the packet error or the packet loss is detected when the captured image is received. In a case where the packet error or the packet loss is detected, the processing proceeds to step S403. In a case where the packet error or the packet loss is not detected, the processing proceeds to step S406.

In step S403, the region determination unit 203 determines the region including the packet error or the packet loss in the captured image on the basis of the information of the packet where the packet error or the packet loss occurs. The region (first region) including the packet error or the packet loss in the captured image is also referred to as an excluded region in the following description.

In step S404, the region determination unit 203 determines whether or not an area of the excluded region determined in step S403 is smaller than a predetermined threshold value. The predetermined threshold value is set in advance on the basis of, for example, an area of the captured image. For example, the predetermined threshold value can be a value obtained by multiplying the area of the captured image by a predetermined coefficient (for example, 0.2). In a case where the area of the excluded region is smaller than the predetermined threshold value, the processing proceeds to step S405. In a case where the area of the excluded region is equal to or larger than the predetermined threshold value, the processing illustrated in FIG. 4 ends.

In step S405, the region determination unit 203 notifies the HMD position and orientation acquisition unit 204 of information on a position of the excluded region. In step S406, the HMD position and orientation acquisition unit 204 specifies the region (second region) obtained by excluding the excluded region from the captured image by using the information of the position of the excluded region, and calculates the position and orientation of the HMD 100 on the basis of the specified region.

In step S404, in a case where the area of the excluded region in the captured image is smaller than the predetermined threshold value, the information processing apparatus 200 acquires the position and orientation of the HMD 100 by using the captured image. On the other hand, in a case where the area of the excluded region in the captured image is equal to or larger than the predetermined threshold value, the information processing apparatus 200 does not use the captured image in order to acquire the position and orientation of the HMD 100. For example, as illustrated in FIG. 3C, in a case where the area of the region where the packet error or the packet loss occurs is equal to or larger than the predetermined threshold value, the feature point for acquiring the position and orientation is not sufficiently detected, and it is difficult to stably estimate the position and orientation.

According to the first embodiment, the information processing apparatus 200 can reduce the influence on the acquisition processing of the position and orientation of the HMD 100 even in a case where the packet error or the packet loss occurs when the captured image is received by wireless communication.

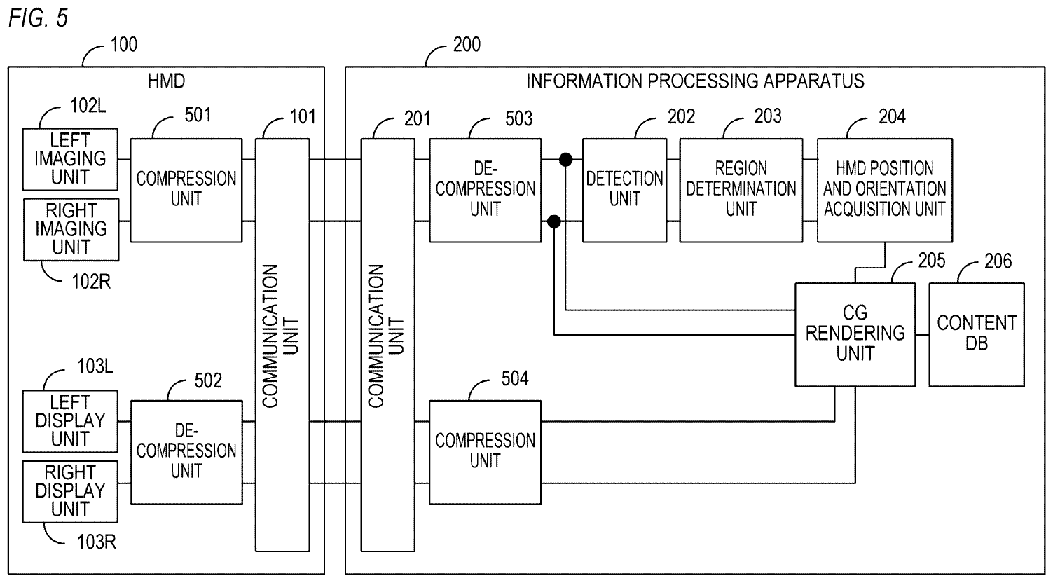

Note that, the images transmitted and received between the HMD 100 and the information processing apparatus 200 may be compressed before transmission and decompressed after transmission. FIG. 5 is an example of a block diagram of the HMD 100 and the information processing apparatus 200 in a case where the images to be transmitted and received are compressed and decompressed. In FIG. 5, the HMD 100 includes a compression unit 501 and a decompression unit 502 in addition to the configuration of FIG. 2. The information processing apparatus 200 includes a decompression unit 503 and a compression unit 504 in addition to the configuration of FIG. 2.

The compression and decompression of the captured image transmitted from the HMD 100 to the information processing apparatus 200 will be described. The compression unit 501 of the HMD 100 compresses the captured image captured by the imaging unit 102. The communication unit 101 transmits the compressed captured image to the information processing apparatus 200. The communication unit 201 of the information processing apparatus 200 receives the captured image in a compressed state. The decompression unit 503 decompresses the compressed captured image. The HMD position and orientation acquisition unit 204 acquires the position and orientation of the HMD 100 on the basis of the region (second region) obtained by excluding the excluded region from the decompressed captured image.

Compression and decompression of a display image transmitted from the information processing apparatus 200 to the HMD 100 will be described. The display image is, for example, the combined image of the CG and the captured image, and is displayed on the display unit 103 of the HMD 100. The compression unit 504 of the information processing apparatus 200 compresses the display image generated by the CG rendering unit 205. The communication unit 201 transmits the compressed display image to the HMD 100. The communication unit 101 of the HMD 100 receives the display image in a compressed state. The decompression unit 502 decompresses the compressed display image. The display unit 103 displays the decompressed display image.

In addition, the HMD position and orientation acquisition unit 204 acquires the position and orientation of the HMD 100 on the basis of the region obtained by excluding the excluded region from the captured image, but the excluded region may further include a region around the region where the packet error or the packet loss occurs.

### Second Embodiment

In the first embodiment, the information processing apparatus 200 specifies the region (second region) excluding the excluded region in the captured image by using information of the position of the region (first region or excluded region) including the packet error or the packet loss in the received captured image. The information processing apparatus 200 acquires the position and orientation of the HMD 100 on the basis of the region specified in the captured image. By contrast, in the second embodiment, before the position and orientation of the HMD 100 are acquired, the information processing apparatus 200 performs image processing on the excluded region such that the excluded region of the captured image is not used to acquire the position and orientation of the HMD 100. Specifically, the information processing apparatus 200 replaces the excluded region with a monochrome image.

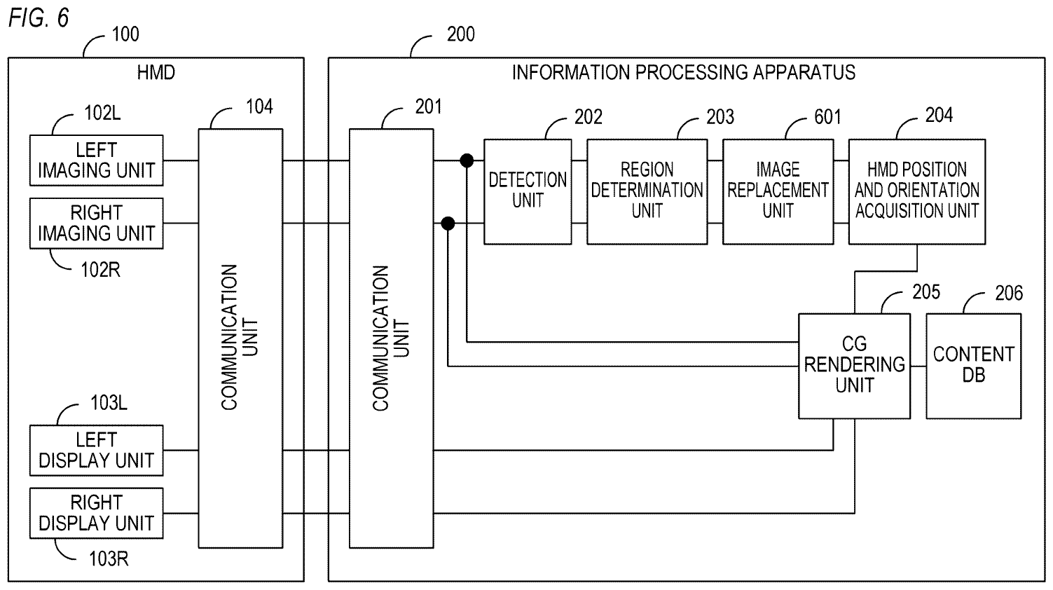

FIG. 6 is an example of a block diagram of the HMD 100 and the information processing apparatus 200 according to the second embodiment. In FIG. 6, the information processing apparatus 200 includes an image replacement unit 601 in addition to the configuration of FIG. 2. The image replacement unit 601 performs image processing on the excluded region determined by the region determination unit 203 so as not to be used to acquire the position and orientation of the HMD 100. That is, the image replacement unit 601 performs image processing on the excluded region such that the position and orientation of the HMD 100 cannot be acquired from the excluded region. For example, the image replacement unit 601 may replace an image of the excluded region with an image in which the feature point is not detected.

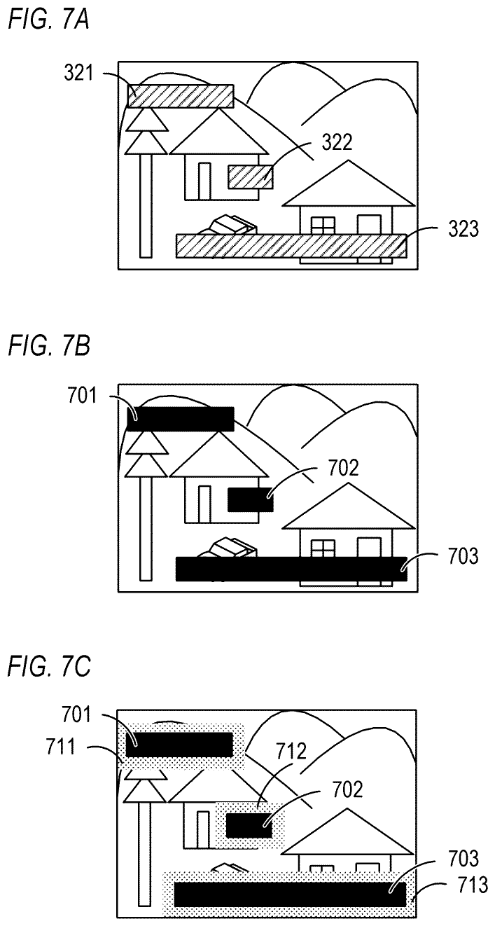

The image processing according to the second embodiment will be described with reference to FIGS. 7A to 7C. FIG. 7A illustrates an example of the captured image in a case where the packet error or the packet loss occurs. Regions 321 to 323 are regions where the packet error or the packet loss occurs.

The image replacement unit 601 performs image processing on the regions 321 to 323 in which the packet error or the packet loss occurs. As an example of the image processing, the image replacement unit 601 replaces the regions 321 to 323 with black images 701 to 703 as illustrated in FIG. 7B. The image replacement unit 601 is not limited to the black image, and may replace the regions 321 to 323 with monochrome images of any color. In addition, as illustrated in FIG. 7C, the image replacement unit 601 may apply gradations 711 to 713 to regions including boundaries of the black images 701 to 703 in FIG. 7B.

Advantages in a case where the gradations 711 to 713 are applied as illustrated in FIG. 7C will be described. When the feature point for self-position estimation by the SLAM is detected, the high-frequency component of the image is detected. In the image processing illustrated in FIG. 7B, the boundaries of the black images 701 to 703 and a real space image becomes high-frequency components, and may be detected as the incorrect feature point. As illustrated in FIG. 7C, the image replacement unit 601 can prevent the high-frequency components from being detected by applying the gradations to the boundary portions (regions including the boundaries) of the black images 701 to 703. The image replacement unit 601 may apply the gradations such that the color becomes closer to black toward an inner side at the boundary portions of the black images 701 to 703.

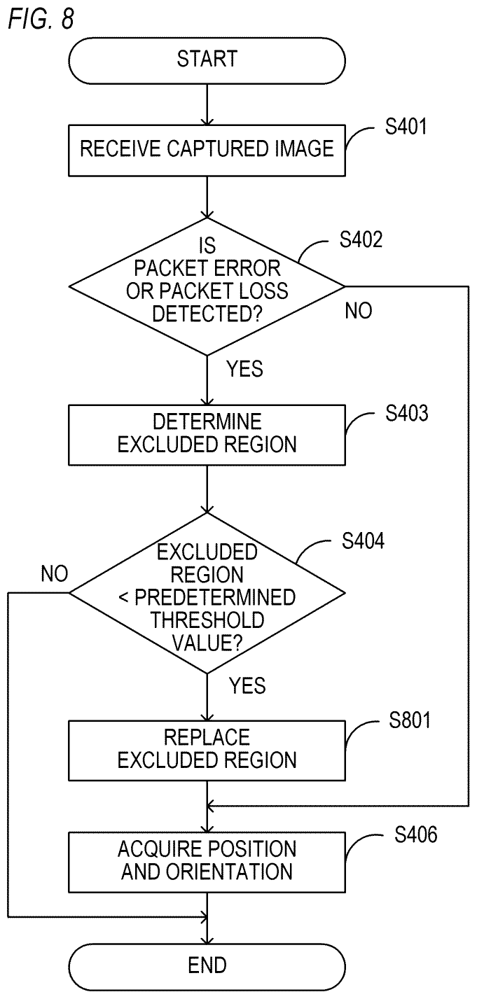

FIG. 8 is a flowchart illustrating position and orientation acquisition processing according to the second embodiment. The position and orientation acquisition processing according to the second embodiment includes processing of step S801 instead of the processing of step S405 of the position and orientation acquisition processing according to the first embodiment in FIG. 4. The same steps as those in the first embodiment are denoted by the same reference numerals, and the description thereof will be omitted.

In step S801, the image replacement unit 601 performs image processing on the excluded region determined by the region determination unit 203 so as not to be used to acquire the position and orientation of the HMD 100. Specifically, the image replacement unit 601 replaces the excluded region with a monochrome image. The image replacement unit 601 may apply the gradations to the boundary portions.

According to the second embodiment described above, the HMD position and orientation acquisition unit 204 can acquire the position and orientation of the HMD 100 on the basis of the captured image obtained by performing image processing on the excluded region, instead of directly using the information of the position of the excluded region. As in the first embodiment, the information processing apparatus 200 can reduce the influence on the acquisition processing of the position and orientation of the HMD 100 even in a case where the packet error or the packet loss occurs when the captured image is received by wireless communication.

### Third Embodiment

In the second embodiment, the information processing apparatus 200 replaces the excluded region with the monochrome image in order to prevent the region (excluded region) including the packet error or the packet loss in the captured image from being used to acquire the position and orientation of the HMD 100. By contrast, in a third embodiment, the information processing apparatus 200 performs image processing of removing high-frequency components from the excluded region.

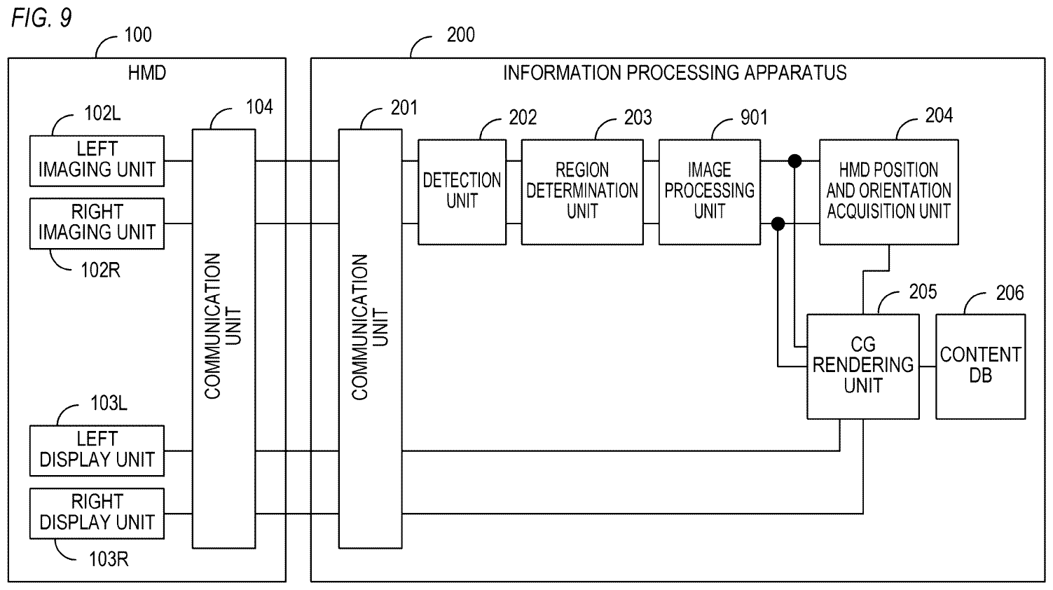

FIG. 9 is an example of a block diagram of the HMD 100 and the information processing apparatus 200 according to the third embodiment. In FIG. 9, the information processing apparatus 200 includes an image processing unit 901 in addition to the configuration of FIG. 2. The image processing unit 901 performs image processing for preventing the excluded region determined by the region determination unit 203 from being used to acquire the position and orientation of the HMD 100. For example, the image processing unit 901 performs image processing of removing the high-frequency components from the excluded region. The image processing unit 901 outputs the image subjected to the image processing to the CG rendering unit 205. The CG rendering unit 205 combines the image processed by the image processing unit 901 with the CG image.

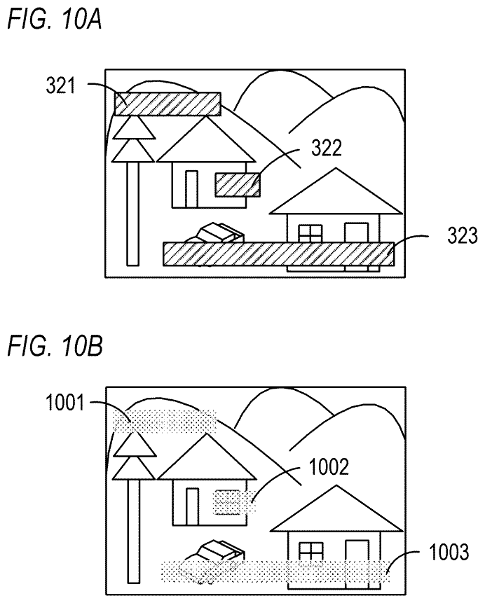

The image processing according to the third embodiment will be described with reference to FIGS. 10A and 10B. FIG. 10A illustrates an example of the captured image in a case where the packet error or the packet loss occurs. Regions 321 to 323 are regions where the packet error or the packet loss occurs.

The image processing unit 901 performs image processing on the regions 321 to 323 where the packet error or the packet loss occurs. As an example of the image processing, the image processing unit 901 removes the high-frequency components from the regions 321 to 323 as illustrated in FIG. 10B. Regions 1001 to 1003 in FIG. 10B indicate regions from which the high-frequency components are removed from the regions 321 to 323.

When the feature point for self-position estimation by the SLAM is detected, the high-frequency component of the image is detected. The image processing unit 901 can prevent the high-frequency component from being detected by removing the high-frequency component from the region where the packet error or the packet loss occurs. The image processing unit 901 may perform processing of removing the high-frequency component including not only the region where the packet error or the packet loss occurs but also the boundary portion.

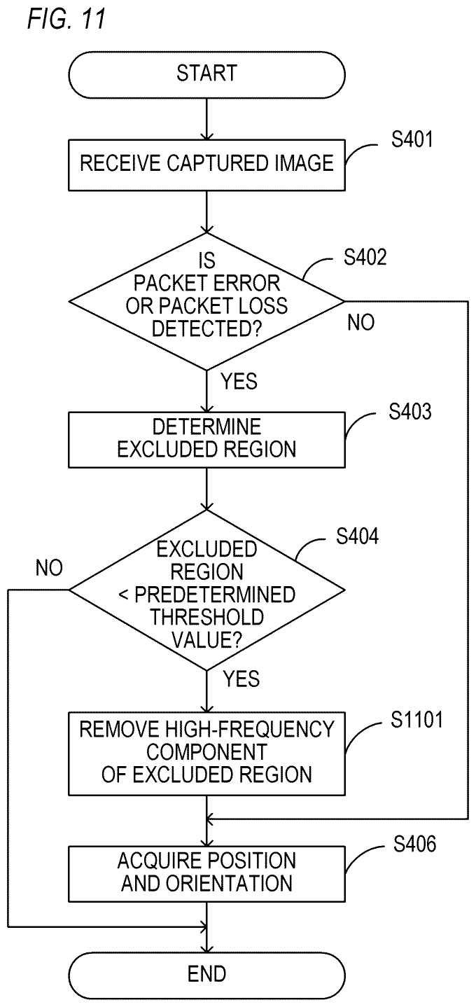

FIG. 11 is a flowchart illustrating position and orientation acquisition processing according to the third embodiment. The position and orientation acquisition processing according to the third embodiment includes processing of step S1101 instead of the processing of step S405 of the position and orientation acquisition processing according to the first embodiment in FIG. 4. The same steps as those in the first embodiment are denoted by the same reference numerals, and the description thereof will be omitted.

In step S1101, the image processing unit 901 performs image processing on the excluded region determined by the region determination unit 203 so as not to be used to acquire the position and orientation of the HMD 100. Specifically, the image processing unit 901 removes the high-frequency component from the excluded region. The image processing unit 901 may perform image processing of removing the high-frequency component on the boundary portion of the excluded region.

According to the third embodiment described above, the HMD position and orientation acquisition unit 204 can acquire the position and orientation of the HMD 100 by using the captured image obtained by performing image processing on the excluded region, instead of directly using the information of the position of the excluded region, as in the second embodiment. As in the first embodiment, the information processing apparatus 200 can reduce the influence on the acquisition processing of the position and orientation of the HMD 100 even in a case where the packet error or the packet loss occurs when the captured image is received by wireless communication.

### Fourth Embodiment

In a fourth embodiment, the information processing apparatus 200 receives a plurality of images captured by a plurality of imaging devices (imaging units), and acquires the position and orientation of the HMD 100 by using at least one image in accordance with a situation where the packet error or the packet loss occurs.

Since the block diagrams of the HMD 100 and the information processing apparatus 200 according to the fourth embodiment are the same as the block diagram of the first embodiment illustrated in FIG. 2, the description thereof will be omitted. Configurations of the HMD 100 and the information processing apparatus 200 according to the fourth embodiment may be the same as the configurations of the second embodiment illustrated in FIG. 6 in a case where the second embodiment is applied to the fourth embodiment, and may be the same as the configurations of the third embodiment illustrated in FIG. 9 in a case where the third embodiment is applied to the fourth embodiment.

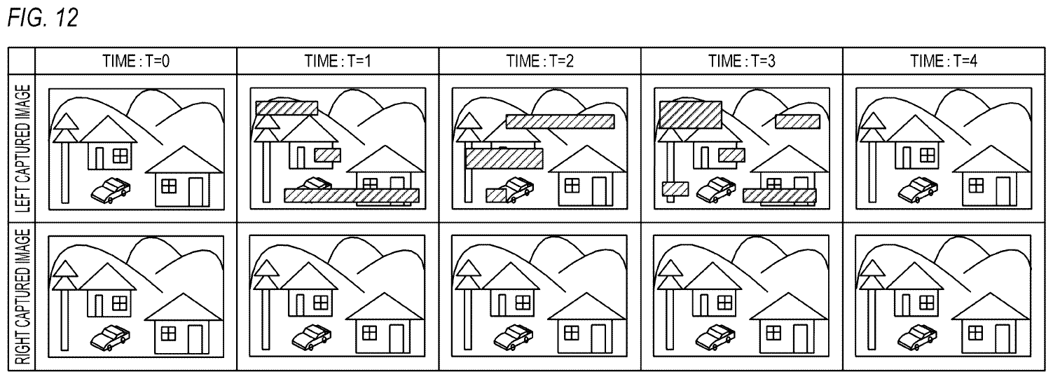

FIG. 12 is a diagram illustrating time-series captured images (frames) by a plurality of imaging units. The images illustrated in FIG. 12 are images received by the information processing apparatus 200 from the HMD 100, and are left captured images captured by the left imaging unit 102L and right captured images captured by the right imaging unit 102R at times T=0 to 4. The left captured images at times T=1, 2, and 3 include the region in which the packet error or the packet loss occurs. The right captured images are normally received.

In a case where there is a plurality of imaging units that image images for acquiring the position and orientation of the HMD 100, when there is deterioration due to the packet error or the packet loss in an image of one imaging unit, the information processing apparatus 200 may acquire the position and orientation of the HMD 100 by using an image of another imaging unit. In the example of FIG. 12, in a case where an area of the excluded region of the left captured image captured by the left imaging unit 102L is larger than a predetermined threshold value and an area of the excluded region of the right captured image captured by the right imaging unit 102R is smaller than the predetermined threshold value, the information processing apparatus 200 acquires the position and orientation by using the right captured images. That is, in a case where the area of the excluded region of the left captured image is larger than the predetermined threshold value at times T=1 to 3, the information processing apparatus 200 acquires the position and orientation of the HMD 100 by using the right captured images.

Note that, in a case where there is deterioration due to the packet error or the packet loss in the image of one imaging unit continuously, the information processing apparatus 200 may acquire the position and orientation of the HMD 100 by using the image of another imaging unit. In the example of FIG. 12, when time T=3, the information processing apparatus 200 may determine that the packet error or the packet loss continuously occurs in the left captured image at times T=1 to 3, and acquire the position and orientation by using the right captured image from time T=3.

In addition, due to the use of the captured images of the plurality of imaging units, the information processing apparatus 200 can align feature points by three-dimensional positions, and can accurately acquire the position and orientation of the HMD 100. In the example of FIG. 12, at times T=0 and 4 when both the left captured image and the right captured image are normally received, the information processing apparatus 200 can acquire the position and orientation of the HMD 100 by using the two images. The information processing apparatus 200 may normally acquire the position and orientation by using the image of one imaging unit, and may acquire the position and orientation of the HMD 100 by using the images of the plurality of imaging units once in several frames.

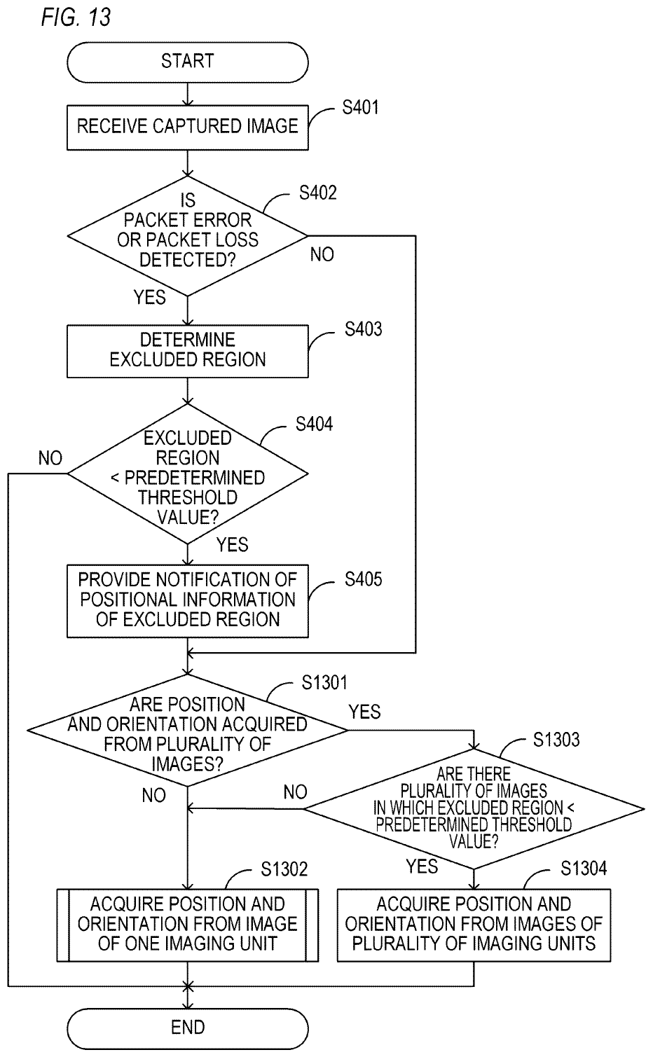

FIG. 13 is a flowchart illustrating position and orientation acquisition processing according to the fourth embodiment. FIG. 13 illustrates an example of processing of normally acquiring the position and orientation by using the image of one imaging unit and acquiring the position and orientation of the HMD 100 by using the images of the plurality of imaging units once in several frames. The position and orientation acquisition processing illustrated in FIG. 13 includes processing of steps S1301 to S1304 instead of the processing of step S406 of the position and orientation acquisition processing according to the first embodiment of FIG. 4. The same steps as those in the first embodiment are denoted by the same reference numerals, and the description thereof will be omitted.

In step S1301, the HMD position and orientation acquisition unit 204 determines whether or not it is timing to acquire the position and orientation from the plurality of images captured by the plurality of imaging units (timing once in several frames). In a case where it is the timing to acquire the position and orientation from the plurality of images, the processing proceeds to step S1303. In a case where it is not the timing to acquire the position and orientation from the plurality of images, the processing proceeds to step 1302.

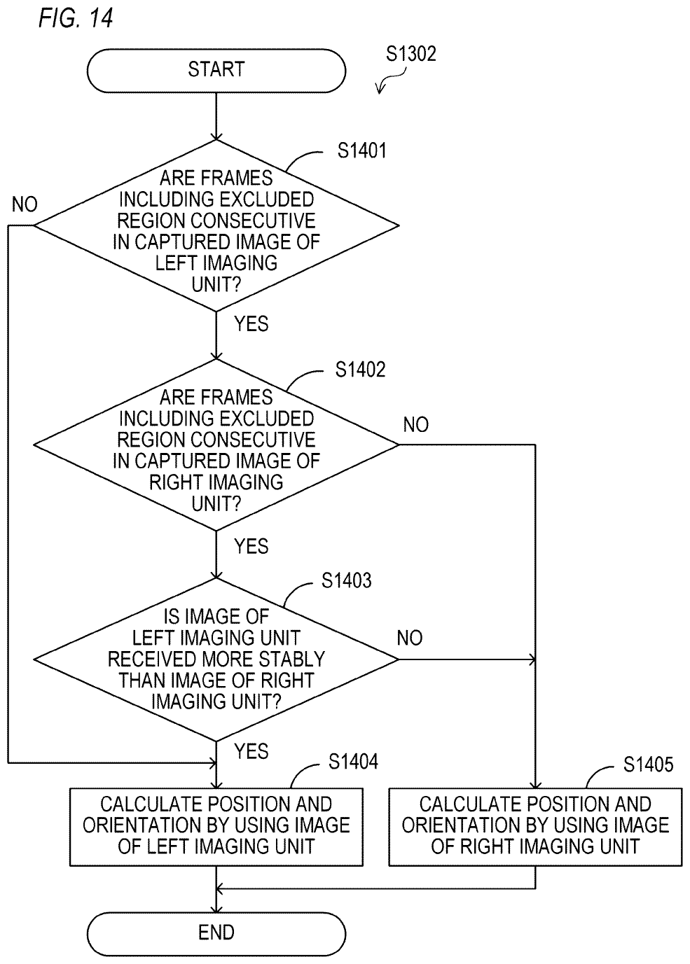

In step S1302, the HMD position and orientation acquisition unit 204 acquires the position and orientation of the HMD 100 by using the image of one imaging unit. The details of the processing in step S1302 will be described later in detail with reference to FIG. 14.

In step S1303, the HMD position and orientation acquisition unit 204 determines whether or not there are the plurality of images in which the area of the excluded region is smaller than the predetermined threshold value among the images captured by the plurality of imaging units. The HMD position and orientation acquisition unit 204 may determine whether or not the area of the region where the packet error or the packet loss occurs is smaller than the threshold value in the images captured by at least two imaging units. In a case where there is the plurality of images in which the area of the excluded region is smaller than the predetermined threshold value, the processing proceeds to step S1304. In a case where there is no plurality of images in which the area of the excluded region is smaller than the predetermined threshold value, since there is a possibility that the feature point is not correctly detected from the plurality of images, the processing proceeds to step S1302.

In step S1304, the HMD position and orientation acquisition unit 204 acquires the position and orientation of the HMD 100 by using two or more captured images in which the area of the excluded region is smaller than the predetermined threshold value. The HMD position and orientation acquisition unit 204 acquires the position and orientation of the HMD 100 on the basis of the region excluding each excluded region in each of two or more captured images in which the area of the excluded region is smaller than the predetermined threshold value.

Note that, in step S404 of FIG. 13, in a case where the area of the excluded region in the captured image is equal to or larger than the predetermined threshold value, the information processing apparatus 200 may proceed to step S1302 instead of terminating the processing illustrated in FIG. 13. In this case, in a case where the area of the excluded region in the image captured by another imaging unit is smaller than the predetermined threshold value, the information processing apparatus 200 can acquire the position and orientation of the HMD 100 by using the captured image of another imaging unit.

FIG. 14 is a flowchart of position and orientation acquisition processing using the image of one imaging unit. The processing of FIG. 14 illustrates the detailed processing of step S1302 of FIG. 13. In step S1401, the HMD position and orientation acquisition unit 204 determines whether or not frames including the region (excluded region) including the packet error or the packet loss are consecutive in the captured image (frame) of the left imaging unit 102L (first imaging device). Note that, the HMD position and orientation acquisition unit 204 may determine whether or not frames in which the area of the excluded region is equal to or larger than the predetermined threshold value are consecutive.

For example, in a case where the number of consecutive frames including the excluded region is equal to or greater than a predetermined number of frames (for example, three frames), the HMD position and orientation acquisition unit 204 can determine that the frames including the excluded region are consecutive. In a case where the frames including the excluded region are consecutive, the processing proceeds to step S1402. In a case where the frames including the excluded region are not consecutive, the processing proceeds to step S1404.

In step S1402, the HMD position and orientation acquisition unit 204 determines whether or not the frames including the region (excluded region) including the packet error or the packet loss in the captured image (frame) of the right imaging unit 102R (second imaging device) are consecutive. Similarly to the left imaging unit 102L in step S1401, the HMD position and orientation acquisition unit 204 can determine whether or not the frames including the excluded region are consecutive for the captured image of the right imaging unit 102R. In a case where the frames including the excluded region are consecutive, the processing proceeds to step S1403. In a case where the frames including the excluded region are not consecutive, the processing proceeds to step S1405.

In step S1403, the HMD position and orientation acquisition unit 204 determines whether or not the captured image of the left imaging unit 102L is received more stably than the captured image of the right imaging unit 102R. For example, the HMD position and orientation acquisition unit 204 can determine that the image of the imaging unit in which the number of frames in which the packet error or the packet loss continuously occurs is smaller is stably received. In addition, the HMD position and orientation acquisition unit 204 may determine that an image having a smaller area (in the case of the plurality of frames, the sum or average value of the areas of the excluded regions of the respective frames) of the excluded region including the packet error or the packet loss is received more stably. The HMD position and orientation acquisition unit 204 may determine which image is stably received by combining these conditions.

In a case where the captured image of the left imaging unit 102L is received more stably than the captured image of the right imaging unit 102R, the processing proceeds to step S1404. In a case where the captured image of the left imaging unit 102L is not received more stably than the captured image of the right imaging unit 102R, the processing proceeds to step S1405.

In step S1404, the HMD position and orientation acquisition unit 204 acquires the position and orientation of the HMD 100 by using the captured image of the left imaging unit 102L. In step S1405, the HMD position and orientation acquisition unit 204 acquires the position and orientation of the HMD 100 by using the captured image of the right imaging unit 102R.

Note that, although FIG. 14 illustrates an example in which the position and orientation of the HMD 100 are acquired by using the images captured by two imaging devices, the information processing apparatus 200 may acquire the position and orientation of the HMD 100 by using images captured by three or more imaging devices. The information processing apparatus 200 may acquire the position and orientation of the HMD 100 by using the most stably received image among the captured images of three or more imaging devices.

According to the fourth embodiment described above, even in a case where the packet error or the packet loss occurs when the captured image is received by wireless communication, it is possible to reduce the influence on the processing of acquiring the position and orientation of the HMD 100 by switching the image to be used.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to stably acquire the position and orientation even in a case where there is an abnormality in a part of the captured image for acquiring the position and orientation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-161043, filed Sep. 18, 2024, which is hereby incorporated by reference herein in its entirety.

What is claimed is:

1. An information processing apparatus comprising:
a processor; and
a memory storing a program which, when executed by the processor, causes the information processing apparatus to
execute reception processing of receiving an image from an apparatus, and
execute acquisition processing of acquiring a position or an orientation of the apparatus on a basis of a second region excluding a first region including a data error or a data loss in the image.

2. The information processing apparatus according to claim 1,
wherein, in the acquisition processing, the second region is specified by using information of a position of the first region, and the position or the orientation of the apparatus is acquired on a basis of a specified second region.

3. The information processing apparatus according to claim 1,
wherein the program, when executed by the processor, further causes the information processing apparatus to perform image processing on the first region of the image such that the position and the orientation of the apparatus are not able to be acquired from the first region, and
wherein, in the acquisition processing, the position or the orientation of the apparatus is acquired by using the image on which the image processing is performed.

4. The information processing apparatus according to claim 3,
wherein, in the image processing, the first region is replaced with a monochrome image.

5. The information processing apparatus according to claim 4,
wherein, in the image processing, gradation is further applied to a region including a boundary of the first region.

6. The information processing apparatus according to claim 3,
wherein, in the image processing, processing of removing a high-frequency component is performed on the first region of the image.

7. The information processing apparatus according to claim 1,
wherein the first region further includes a region around a region where the data error or the data loss occurs.

8. The information processing apparatus according to claim 1,
wherein, in the acquisition processing, in a case where an area of the first region is smaller than a predetermined threshold value, the position or the orientation of the apparatus is acquired on a basis of the second region of the image.

9. The information processing apparatus according to claim 1,
wherein, in the reception processing, a plurality of images captured by a plurality of imaging devices are received, and
wherein, in the acquisition processing, in a case where, among the plurality of images including a first image and a second image, an area of the first region of the first image captured by a first imaging device is larger than a predetermined threshold value and an area of the first region of the second image captured by a second imaging device is smaller than the predetermined threshold value, the position or the orientation of the apparatus is acquired by using the second image.

10. The information processing apparatus according to claim 1,
wherein, in the reception processing, a plurality of images captured by a plurality of imaging devices are received, and
wherein, in the acquisition processing, the position or the orientation of the apparatus is acquired on a basis of the second region of each of two or more images in which an area of the first region is smaller than a predetermined threshold value, among the plurality of images.

11. The information processing apparatus according to claim 1,
wherein, in the reception processing, a plurality of images captured by a plurality of imaging devices are received, and
wherein, in the acquisition processing, the position or the orientation of the apparatus is acquired on a basis of the second region of an image received most stably among the plurality of images.

12. The information processing apparatus according to claim 11,
wherein, in the acquisition processing, in a case where the plurality of images are continuously received, it is determined that an image in which a number of frames in which the data error or the data loss continuously occurs is smaller is stably received.

13. The information processing apparatus according to claim 11,
wherein, in the acquisition processing, it is determined that an image in which an area of the first region is smaller is received more stably.

14. The information processing apparatus according to claim 1,
wherein, in the reception processing, the image is received in a compressed state, and
wherein, in the acquisition processing, a compressed image is decompressed, and the position or the orientation of the apparatus is acquired on a basis of a second region obtained by excluding the first region from a decompressed image.

15. An information processing method comprising:
receiving an image from an apparatus, and
acquiring a position or an orientation of the apparatus on a basis of a second region excluding a first region including a data error or a data loss in the image.

16. A non-transitory computer readable medium that stores a program, wherein the program causes a computer to execute an information processing method comprising:
receiving an image from an apparatus, and
acquiring a position or an orientation of the apparatus on a basis of a second region excluding a first region including a data error or a data loss in the image.
